(19) United States
(12) Patent Application Publication
(10) Pub. No.: US 2014/0231654 A1
(43) Pub. Date: Aug. 21, 2014

(54) APPARATUS FOR DETECTING RADIATION FIELDS

(71) Applicant: NORDION (Canada) Inc., Ottawa (CA)

(72) Inventors: PETER REID, OTTAWA (CA); NIGEL VEZEAU, OTTAWA (CA)

(73) Assignee: NORDION (Canada) Inc., Ottawa (CA)

(21) Appl. No.: 14/042,093

(22) Filed: Sep. 30, 2013

Related U.S. Application Data
(60) Provisional application No. 61/753,179, filed on Jan. 16, 2013.

(51) Int. Cl. G01T 1/16; G01T 1/20; G01T 1/24; G01T 1/185

(52) U.S. Cl. CPC G01T 1/16; G01T 1/185; G01T 1/2006; G01T 1/24
USPC 250/366; 250/394; 250/382; 250/370.01

(57) ABSTRACT

A radiation detector that can be used to detect the intensity of radiation fields and provide feedback to the user about the location of radiation fields. The radiation detector has a number of radiation detection volumes that are arranged in a staggered pattern relative to a sweeping direction of the radiation detector. The staggered arrangement of the detection volumes allows a large gap-free detection volume that is composed of smaller detection volumes in order to provide adequate sensitivity.

### CROSS-REFERENCE TO RELATED APPLICATIONS

The present non-provisional patent application claims priority to U.S. Provisional Patent Application Ser. No. 61/753,179 filed on Jan. 16, 2013 entitled “Apparatus For Detecting Radiation Fields” the contents of which are incorporated herein by reference.

### TECHNICAL FIELD

The current description relates to an apparatus for detecting radiation fields, and in particular to an apparatus for detecting fields of ionizing radiation using radiation detection volumes.

### BACKGROUND

Radiation cannot be detected by the human body. However, various instruments are available for measuring radiation intensity, often referred to as fields. For example, a Geiger counter includes a Geiger-Mueller (GM) tube that generates an electrical pulse when radiation enters the GM tube, and a rate meter or counter that provides feedback on the amount of radiation detected by the GM tube. The feedback may be provided through auditory feedback such as beeps or clicks or through visual feedback such as meters or gauges.

FIG. 1 depicts a schematic of a radiation detector that may be used for detecting radiation. The detector 102 comprises a radiation sensor, such as a GM tube 102 that can be hand held. The GM tube 102 is electrically connected, such as by wires 104, to a rate counter 106, which provides feedback to the user based on the intensity of radiation detected. The feedback may be visual, such as through a gauge 108, or auditory, such as through a speaker 110. In use, the GM tube 102 can be moved about an area being surveyed to determine locations of higher or lower radiation.

Radiation intensity measurements from a single detection volume are an average reading through the entire detection volume. A single detector cannot differentiate between a localized intense radiation field, and a large-area diffuse radiation field if the average reading through the probe volume is the same in either situation. Larger volume detectors are desirable when there is a need to measure a large area, but are not able to discriminate small intense fields from large area fields of lower intensity. Small volume detectors offer more precision when scanning an area, but measurements become very time consuming to do a thorough survey. Typically, a probe volume is selected to provide a trade-off between measurement speed and precision. This can lead to errors in measurement if a larger volume detector is used in the presence of highly collimated and localized fields. In some applications, intense fields can be underestimated or missed entirely during measurement if a large volume probe is used.

### BRIEF DESCRIPTION OF THE DRAWINGS

Embodiments are described herein with references to the appended drawings, in which:

FIG. 1 depicts a prior art radiation detector;

FIG. 2 depicts a perspective view a radiation detector in accordance with the present disclosure;

FIG. 3 depicts a perspective view of internal components of the radiation detector of FIG. 2;

FIG. 4 depicts a perspective view of further internal components of the radiation detector of FIG. 2;

FIG. 5 is a layout diagram of a sensing portion of the radiation detector of FIG. 2;

FIGS. 6 to 11 are perspective views depicting the use of a radiation detector in accordance with the present disclosure;

FIG. 12 is a perspective view of a further radiation detector in accordance with the present disclosure;

FIG. 13 is a layout diagram depicting a further possible arrangement of detection volumes;

FIG. 14 is a layout diagram depicting a further possible arrangement of detection volumes; and

FIG. 15 is a block diagram of components of the present disclosure.

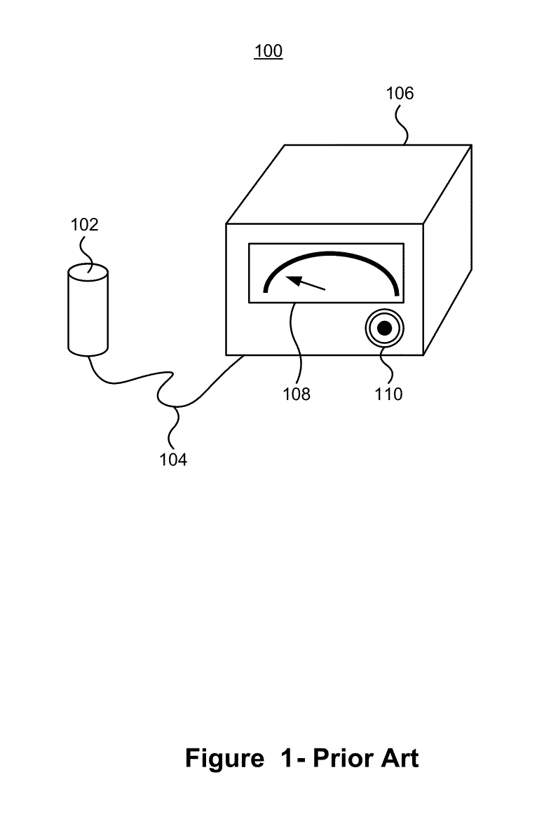

### DETAILED DESCRIPTION

In accordance with the current disclosure, there is provided an apparatus for detecting radiation comprising an elongate frame having a longitudinal axis; and a plurality of radiation detection volumes located along the frame and arranged in a staggered pattern relative to a sweeping direction perpendicular to the longitudinal axis.

Ionizing radiation, referred to simply as radiation, radiation fields, or fields herein for brevity, is used in a number of industries, from medical imaging and treatments, to power generation to non-destructive testing and imaging in industry. Regardless of the application, a source of radiation is present. Although the radiation sources have numerous beneficial uses, it is generally understood that there is some level of risk to health that is proportional to exposure. Management of radiation exposure follows a practise referred to as ALARA (as low as reasonably achievable) and the establishment of dose limits for the exposure of the public and for nuclear radiation workers. In addition, there are radiation field measurements required on packaging containing radioactive materials to permit transport of radioactive goods and materials. Radiation surveys are used to measure and locate radiation fields. As an example, when a radiation source is being sent to a destination, it is sent in a shielded container of lead or other appropriate material such as tungsten or depleted uranium to reduce the intensity of the radiation fields on the exterior of the container. The container may be surveyed using a radiation detector to ensure that radiation fields emitted from the container are within acceptable limits. However, within the field of radiation emitting from the package, there can be higher radiation fields resulting from small cracks in the shielding or other unintended openings such as due to an improperly fitted lid. The location or locations and intensity of these higher radiation fields may be difficult to locate and measure accurately with previous radiation detectors. Ideally, a radiation measurement device can provide a measurement indicative of the actual intensity of a radiation field. However, the measurement of a radiation field is indicative of the amount of radiation passing through a detection volume, and as a result a pin point radiation field of high intensity may have the same measured intensity as a larger area radiation field with a lower intensity if the detection volume can cover the larger radiation field.

Further, in areas that work with radiation sources, specific shielded areas, referred to as ‘hot cells’, are provided for working with the radiation sources while preventing or reducing potential human exposure to the radiation. Radiation surveys of the hot cell may be periodically performed to monitor the radiation field and ensure that there are no cracks or openings in the shielding of the hot cell that allow higher than acceptable radiation fields to be present outside of the hot cell. However, again, within a radiation field there may be localized higher radiation fields that are difficult to detect with previous radiation detectors, since the measured intensity is representative of the radiation passing through the detection volume as a whole.

Further still, it may be desirable to periodically perform radiation surveys of areas that could possibly be contaminated with radioactive materials. For example walls or floors of areas that work with radiation sources may periodically be surveyed to locate possible radiation contamination.

Further still, it may be desirable to periodically perform radiation surveys of areas that could have fields present. For example, work spaces where ionizing radiation is present, such as facilities that handle, process, or transport active material; x-ray facilities; research facilities, areas using linear accelerators, and so on. Radiation surveys of areas where ionizing energy is employed are used to ensure the radiation exposure to workers is minimized.

Further still, it may be desirable to detect the presence of ionizing radiation at ports of entry, security checkpoints, or equipment and facilities used for material transport.

As described further below, a radiation detector may have an elongate sensor comprised of a number of individual detection volumes. The use of a number of small detection volumes provides a large sensing volume while allowing precise field intensity measurements to be made within the combined detector volume. Further, as described below, the individual detection volumes may be arranged in a staggered pattern to ensure that adjacent detection volumes overlap relative to the general direction of movement of the radiation detector. The overlapping of the adjacent individual detection volumes ensures that when the radiation detector is moved in a general scanning or sweeping direction, there are no gaps between adjacent detection volumes through which a localized radiation field could possibly pass undetected. As such, the staggered arrangement of the individual detection volumes act as a continuous combined detection volume providing a gap-free detection volume. Further, the radiation detector may have a handle at one end of the elongate frame so that a user's hand can be kept a safer distance from areas being surveyed.

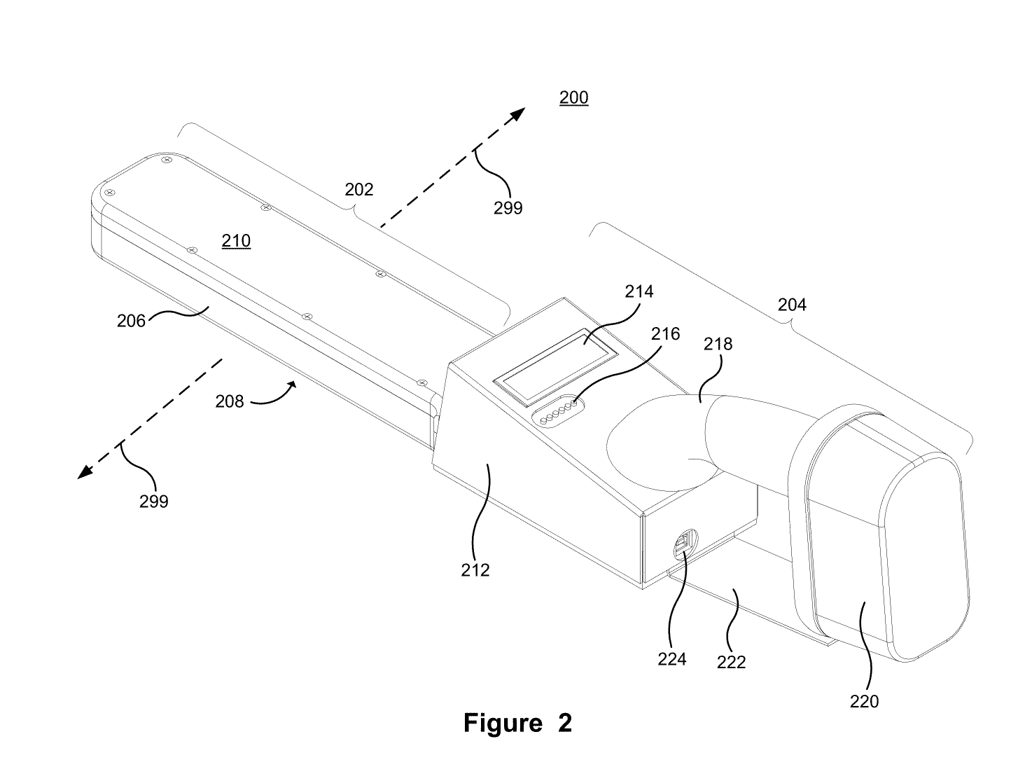

FIG. 2 depicts a perspective view a radiation detector in accordance with the present disclosure. As depicted, the radiation detector 200 is a hand held device. The radiation detector 200 has a general sensing portion 202 that houses individual radiation detection volumes arranged in a staggered pattern, and a handle portion 204 allowing an operator to use the detector 200 with one hand. As depicted, the handle portion 204 is located at an end of the sensing portion 202, and as such an operator's hand and body can be kept out of the area being surveyed for radiation fields.

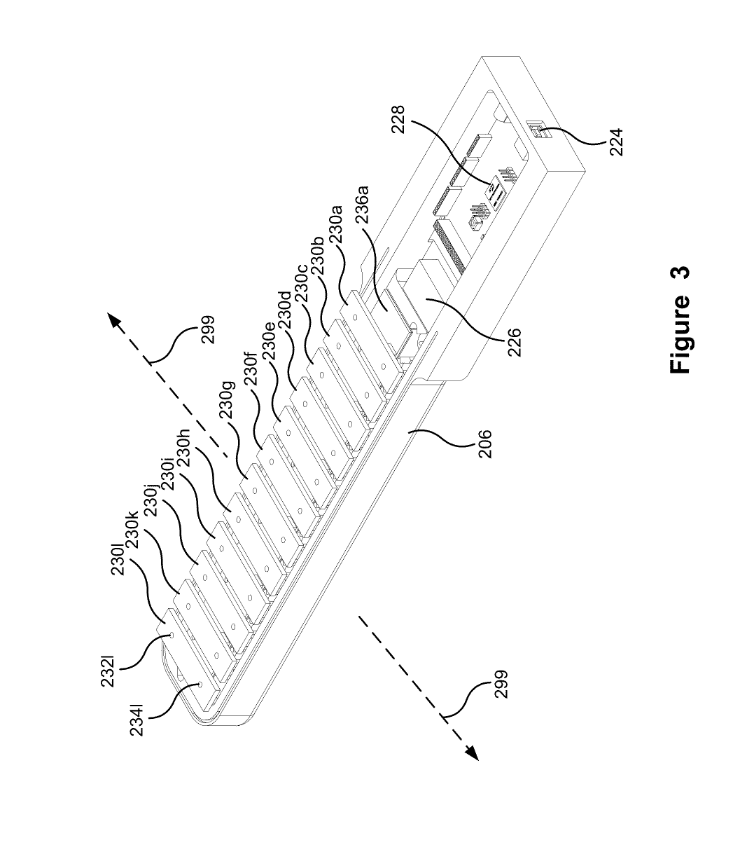

The sensing portion 202 may have an elongated rectilinear shape that extends away from the handle portion 204. The elongated shape of the sensing portion 202 houses a plurality of individual detection volumes that combined allows a large area of a surface to be scanned by the detector 200. The sensing portion 202 is moved across the surface being scanned in a sweeping direction that is generally perpendicular to the longitudinal direction of the sensing portion 202. The sweeping direction is depicted by dashed line 299. The sensing portion 202 may comprise a lower frame 206, which is described further with reference to FIG. 3, that provides a sensing surface 208. The sensing surface extends across the bottom of the sensing portion 202. A display cover 210 may be secured to the lower frame 206. As described further below, the display cover 210 may be a transparent or translucent material, through which a plurality of light emitting diodes (LEDs) or other visual feedback device such as an LCD which can display a spectrum of colours are visible to provide feedback with regard to the amount of radiation detected at each individual detection volume. Although any LEDs or other display technology may be used, the use of coloured LEDs, which may emit red, green and blue light to display a spectrum of colours, may be used to provide various information based on the colour and/or intensity of the LEDs. The display cover 210, or more particularly the LEDs visible through the display cover 210, act as a display for indicating radiation field intensities detected. As described further below, the display may provide simple and intuitive feedback as to the location and intensities of any detected radiation fields on a surface being scanned.

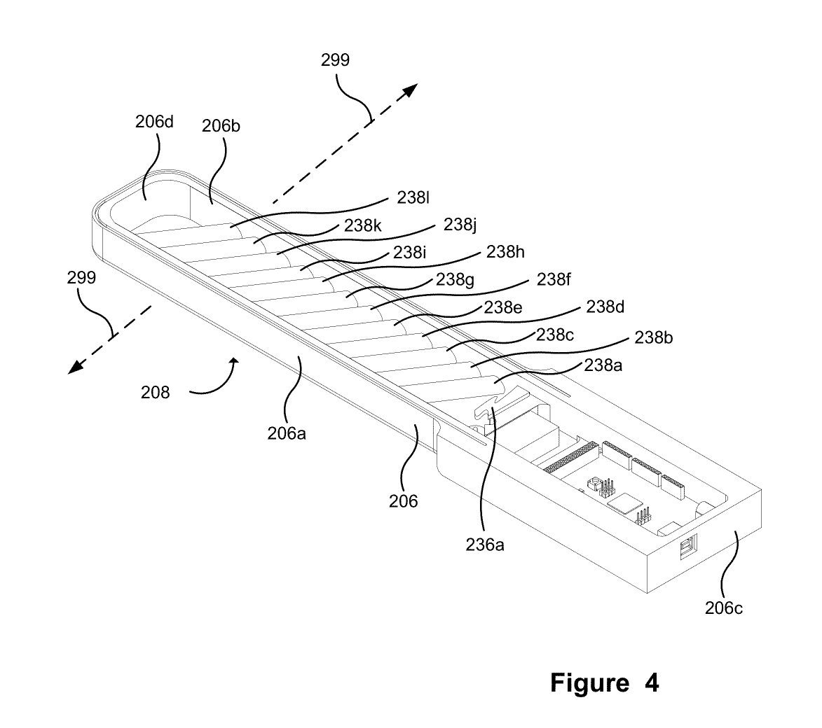

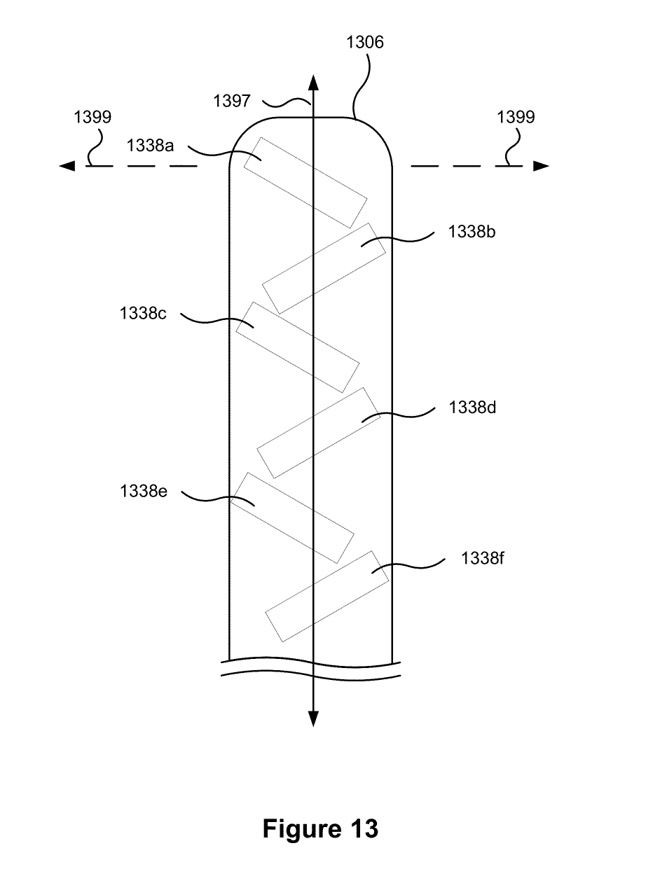

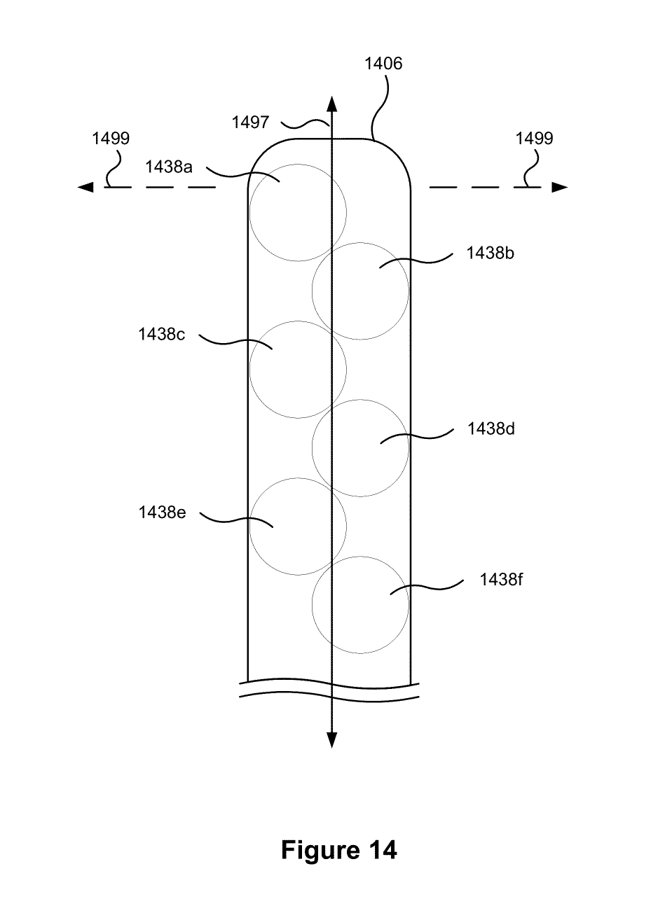

The sensing portion 202 comprises an enclosed space that contain components of a display for indicating field intensities detected as well as a plurality of individual radiation detection volumes. As described further with regards to FIG. 4, the radiation detection volumes are located along the frame 206 and are arranged in a staggered pattern. Although other staggered arrangements are possible, such as those described with regards to FIGS. 13 and 14, the individual detection volumes may be arranged at an angle so that when the detector is moved in the general sweeping direction 299 there are no gaps between adjacent detection volumes through which small radiation fields could pass undetected. A large and gap free sensing area is provided that can use a number smaller sized individual radiation detection volumes. As such, the radiation detector 200 can provide a large sensing area to quickly survey large areas while still providing high sensitivity and the ability to detect even small pin point radiation fields.

The sensing portion 202 is connected to the handle portion 204 at one end. As is evident from FIG. 3, the frame 206 may extend to the handle portion 204. An enclosure 212 covers the internal electronics of the detector 200 and can provide a mounting point for other components. As depicted, the detector 200 may include a second display 214 for displaying information such as operating information about the detector including battery levels, operation modes, and other relevant information. The second display 214 may also display detecting information such as an average of the radiation field intensity detected by individual detection volumes or the combination of all of the detection volumes, a maximum of radiation detected and/or threshold values of the detector. The handle portion 204 may further include one or more input controls 216. The input controls allow the detector 200 to be operated. The input controls 216 may allow different modes of operation of the detector to be selected, setting of detector options such as colors used by the display and audio feedback options, and control of operation of the detector.

The handle portion 204 includes a handle 218. The handle 218 is depicted as extending from the enclosure 212 and having a removable battery pack 220 attached at its end. Although the battery can be located in various locations, or alternatively the detector could receive power by electrically connecting to an external power source, locating the battery 220 at the end of the handle 218 may be advantageous from an ergonomic perspective. The weight of the battery 220 can at least partially balance the weight of the sensing portion 202, possibly making the detector easier to use. A brace 222 may be provided to secure a lower portion of the battery 220, or connection point of the battery 220, to the frame 206 or enclosure 212 to provide a more solid connection of the handle 218 to the frame 206 and/or enclosure 212 The handle portion 204 may also include a communication interface 224 for communicating with an external device. The communication interface 224 may be a wired interface as depicted or could be provided by a wireless interface, such as a WiFi™ or Bluetooth™ radio. The communication interface 224 may be used to program or control the detector and/or to download or transmit detection information to the external device.

FIG. 3 depicts a perspective view of internal components of the radiation detector of FIG. 2. The display cover 210 and enclosure 222 have been removed from the detector 200 in FIG. 3. As depicted, the interior space of the detector 200 houses various components of the detector, including a plurality of display components 230a-1 (referred to collectively as display components 230) each having at least one LED. As depicted, each of the display components 230 comprises two LEDs, which may be RGB LEDs that are able to display a spectrum of colours, of which only 2321 and 2341 are labelled for clarity of the Figure. The interior space may also house a plurality of conditioning circuitry, of which only 236a is labelled for clarity of the Figure. Each of the display components and conditioning circuitry is associated with a respective radiation detection volume 238a-1 (see FIG. 4). The display components 230 may be arranged above the respective detection volumes 238 so that they can provide simple visual feedback on the intensities of radiation fields detected, the location of the detected radiation field relative to the radiation detector, or any other information about the operating status of the radiation detection volumes.

In addition to housing the sensor components, namely the display components 230, conditioning circuitry and detection volumes 238, the frame may provide interior space housing the electronics of the detector. The electronics may include power circuitry 226 for providing the required current and voltages required by the detector 200 and a microcontroller 228.

FIG. 4 depicts a perspective view of further internal components of the radiation detector of FIG. 2. The display components 230 and conditioning circuitry 236 have been removed in FIG. 4. As depicted, twelve detection volumes 238a-1 (referred to collectively as detection volumes 238) are arranged along the frame 206 in a staggered pattern. The staggered pattern of the detection volumes provides a continuous gap-free combined detection volume in a sweeping direction. The frame 206 may have opposite side walls 206a, 206b that are connected together by end walls 206d, 206c. The frame 206 may further comprise a sensing surface 208 that is placed adjacent to a surface or area being scanned when the detector is in use. As depicted, the individual detection volumes 238 may be arranged within the detector 200 so that they are at an angle to the sweeping direction. The detection volumes 238 are arranged so that adjacent detection volumes overlap with each other in the sweeping direction. As described above, the sweeping direction 299 is the general direction the detector is moved during operation and is generally perpendicular to the longitudinal axis of the detector 200. As will be appreciated, movement of the detector 200 does not need to be constrained to movement in the sweeping direction.

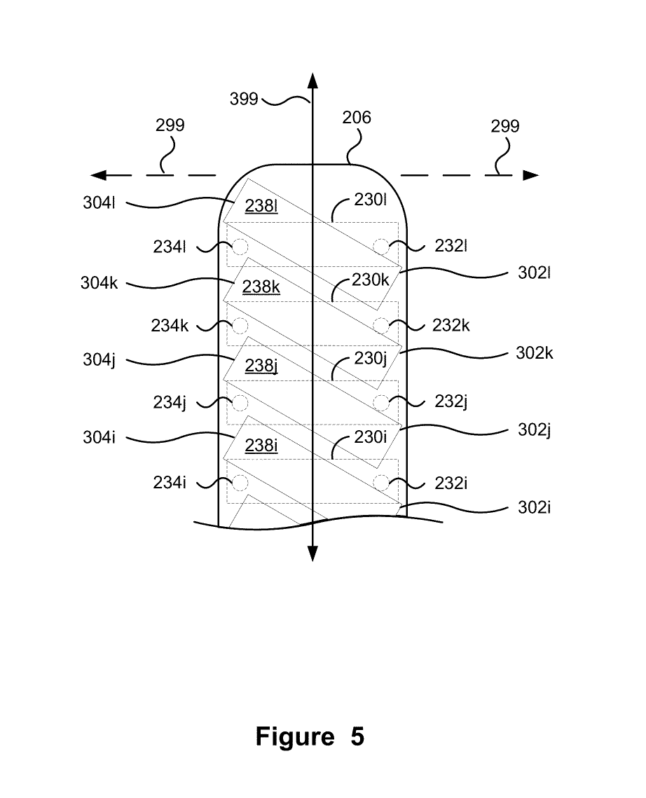

FIG. 5 is a block diagram of a sensing portion of the radiation detector of FIG. 2. The block diagram depicts the arrangement of the detection volumes 238 and the associated display components. It will be appreciated that only the ‘top’ detection volumes 238i-1 and display components 230I-1 are depicted.

The detection volumes 238 are arranged along the frame 206. The detection volumes 238 are located along a longitudinal axis 399 of the frame 206. The detection volumes 238 are depicted as being centered within the width of the frame 206; however, it is contemplated that the detection volumes can be located off-center within the frame 206. The detection volumes 238 are located within the frame so that there is a continuous and gap-free combined detection volume when the detector is moved in the sweeping direction 299. The detection volumes 238 may be arranged within the frame 206 so adjacent detection volumes overlap each other in the sweeping direction. As shown, each of the detection volumes 238 have respective first ends 302i-1 and second ends 304i-1 that are opposite each other. With regard to adjacent detection volumes 238j and 238k, the first end 302k of detection volume 238k overlaps the second end 304j, i.e. the opposite end, of the adjacent detection volume 238j in the sweeping direction 299. The overlapping detection volumes 238 provide a continuous, gap-free detection volume when the detector is moved in the general sweeping direction. The continuous detection volume is provided by smaller individual detection volumes. As such, the detector provides localized sensitive radiation detection over a large sensing area.

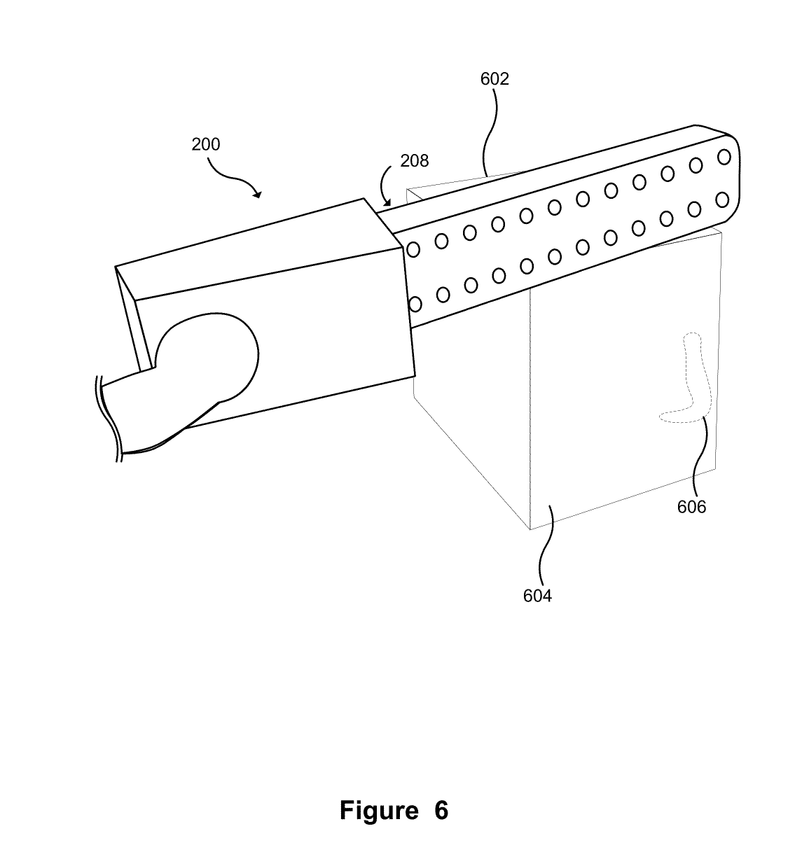

As depicted, the detection volumes 238 are arranged along the frame 206 with a respective display component arranged ‘above’ each of the detection volumes 238. ‘Above’ is with regard to a side of the detector 200 that is placed adjacent a surface or area being scanned. That is, the display components 230 are located on an opposite side of the respective detection volumes 238 from a sensing surface of the frame 206. Each of the display components 230 are depicted as having first LEDs 232i-1 and second LEDs 234i-1. The display components 230 provide a display that may indicate radiation field intensities detected at the plurality of radiation detection volumes. As described further with regards to FIGS. 6-10, the display comprised of the plurality of display components can provide simple and intuitive visual feedback about detected radiation field intensities. With the individual display components 230 located above an associated detection volume, the visual feedback also provides an indication as to the location of the radiation field.

The display components 230 may have one or more LEDs that provide visual feedback on the field intensity detected. If multiple LEDs are provided on each display component 230, different measurement information may be provided. For example, a first LED 232 can provide feedback on the field intensity detected by the respective detection volume. The field intensity measured by an individual detection volume could be used to vary the intensity, colour or both the colour and intensity of the first LED of the display component associated with the detection volume. If the display components comprise additional LEDs, for example second LEDs 234 as depicted, additional visual feedback can be provided. It is contemplated that the additional LEDs could provide additional feedback on various parameters relevant to the detectors operation. For example, an LED could be turned on or off, or its colour and/or intensity varied, depending on whether or not the radiation field intensity detected by the associated detection volume is above or below a threshold value. The threshold value could be set by the operator or programmed in other ways. Further, the LEDs could be controlled based on an average of the radiation field intensity of all of the radiation volumes of the detector, a rate of change of the radiation rate detected at an individual detector, or a rate of change of the radiation rate detected at an individual detector in comparison to the average rate of change of the radiation rate. The LEDs may display other characteristics of the detector including, for example, battery capacity remaining, loss of high voltage supply for biasing GM tubes if used as detection volumes, overall intensity detected with respect to a threshold value, and/or unsafe conditions. Further, the LEDs may provide different information in different modes of operation. For example, the LEDs may display radiation field intensity measurements of associated individual detection volumes in a first mode. In a second mode the entire array of LEDs may be configured to display a bulk property if a measurement criterion is satisfied. An example of this is to have the entire array of LEDs display a blue colour if the average field intensity and/or the peak field intensity are below a threshold. Once the threshold level is exceeded on either average or peak field intensities, the entire array may switch to a bright red to clearly alert the user of a radiation field intensity above the predetermined threshold. This mode of operation may help an operator to quickly locate areas requiring further attention, which can then be surveyed using the first mode of operation

The detection volumes may be connected to conditioning circuitry (depicted in FIG. 3). The conditioning circuitry may remove noise from a signal from the detection volumes and provide the cleaned detection signals to the microprocessor at an appropriate voltage. The appropriate voltage may depend upon the particulars of the microprocessor used. For example, the detection signals of each of the detection volumes provided to the microprocessor by the conditioning circuitry may be a digital signal which switches from logical low to logical high and back to low again each time a pulse is detected. Alternately, the conditioning circuitry may provide the measurement data to the microprocessor in the form of a digital communication passing a value from each detector, or as an analog voltage or current that is proportional to the field intensity measured in each sensing volume. The microprocessor processes the signals and controls the display to provide the desired feedback. For example, the microprocessor may control the characteristics of the display, such as colour and intensity, of the LEDs 232, 234. Additionally, the microprocessor may provide audio feedback and may output information on the user interface screen

FIGS. 6 to 11 are perspective views depicting the use of a radiation detector in accordance with the present disclosure. In FIGS. 6 to 10, a package is depicted that is being scanned to survey the radiation fields. The package 602 may be a package of radiation sources that are being transported. The radiation sources may be enclosed within a lead container to attenuate radiations fields; however, the package is scanned to ensure that the radiation levels are acceptable, as well as determine the location of the highest radiation field present on the exterior of the container. As depicted, one side 604 of the package is being scanned. The dashed line 606 is intended to depict a higher than expected radiation field. The radiation field 606 may be the result of a crack in the lead container or other unintended opening or failure of the container.

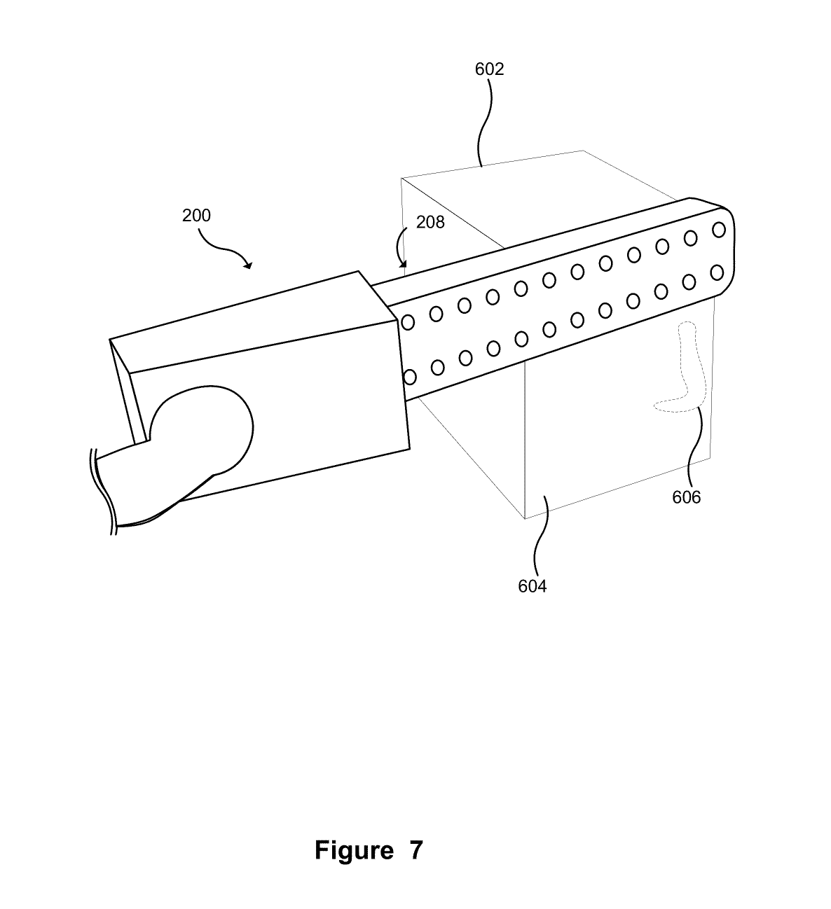

When the surface 604 is being scanned, the detector 200 is placed so that the sensing surface 208 is adjacent the surface 604 being scanned. As the scanning begins, the detector is moved in the sweeping direction, which is down in FIGS. 6-10. It is assumed that there is acceptable and uniform radiation field present, except in the area of the radiation field depicted at 606. As such, all of the detection volumes of the detector 200 will detect a uniform, low level of radiation and so the LEDs will be a normal operating colour and/or brightness as depicted in FIGS. 6 and 7.

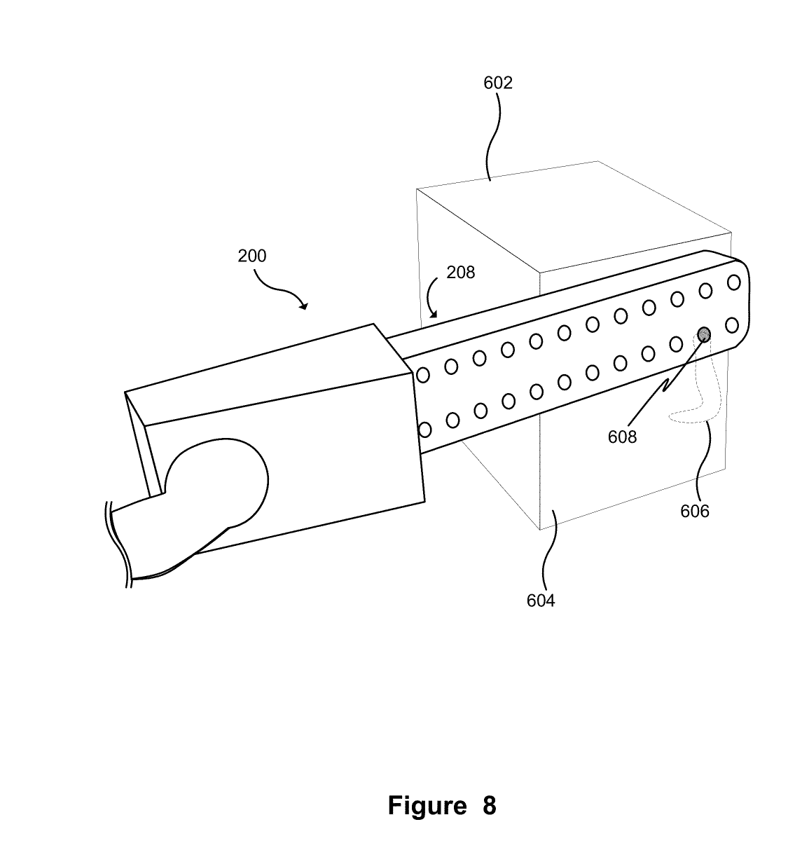

In FIG. 8, the detector is moved over the field 606 where there is a higher than expected radiation field. The radiation intensity is detected at one of the radiation volumes, and as such the associated LED 68 is controlled to provide feedback as to the radiation field intensity detected. Since only a small portion of the detection volume is over the radiation field 606, the detected intensity will be relatively low. The brightness, colour or both the brightness and colour of the LED 68 may be varied based on the detected radiation field intensity.

In addition to controlling one of the LEDs based on the radiation intensity detected by the detection volume, the detector may control the other one of the LEDs based on whether or not the detected radiation field intensity of the individual detection volumes is above or below a threshold. In FIG. 8, it is assumed that the radiation intensity detected by the detection volume over the radiation field 606 is below a threshold and as such the second LED associated with the detection volume remains displaying the normal operating colour and/or intensity.

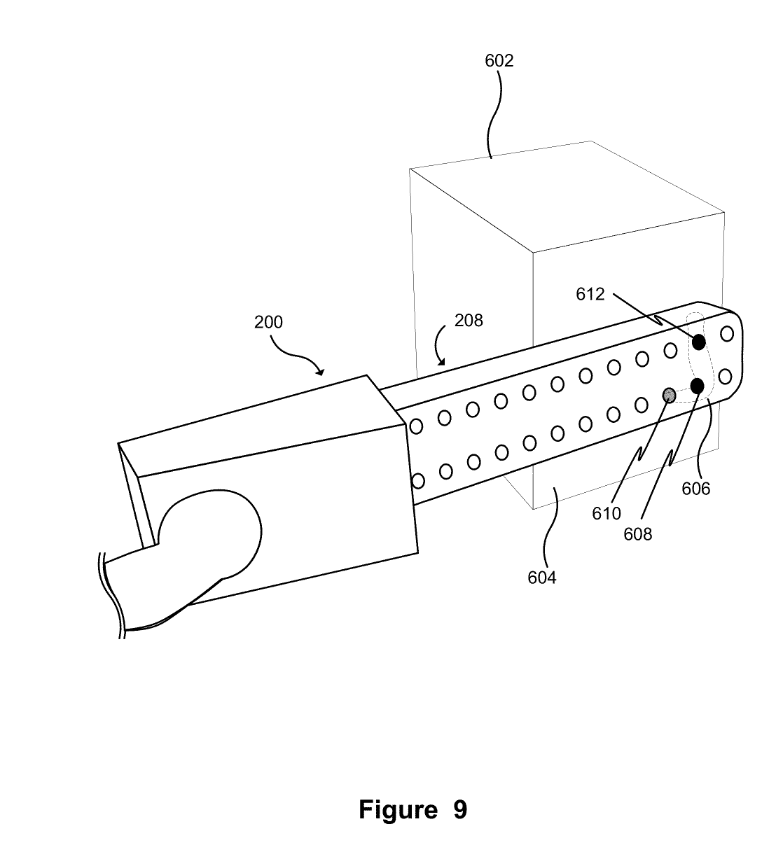

As the detector 200 continues to be moved in the sweeping direction as depicted in FIG. 9, the detection volume is moved over a larger portion of the radiation field 606. As such, the radiation intensity detected by the detection volume increases. As depicted, the brightness of the first LED 68 increases. Additionally, it is assumed that the increased radiation intensity detected by the detection volume causes the detected intensity to cross the threshold, and as such, the second LED associated with the detection volume 612 is turned on, or the colour and/or brightness controlled, to indicate the rate has crossed the threshold. Further, a second detection volume comes over the radiation field 606, and as such, the brightness of the associated LED 610 is controlled accordingly to provide feedback on the detected radiation field intensity. It is assumed that the field intensity detected by the second detection volume has not crossed the threshold and as such the associated second LED has not changed from the normal operating colour.

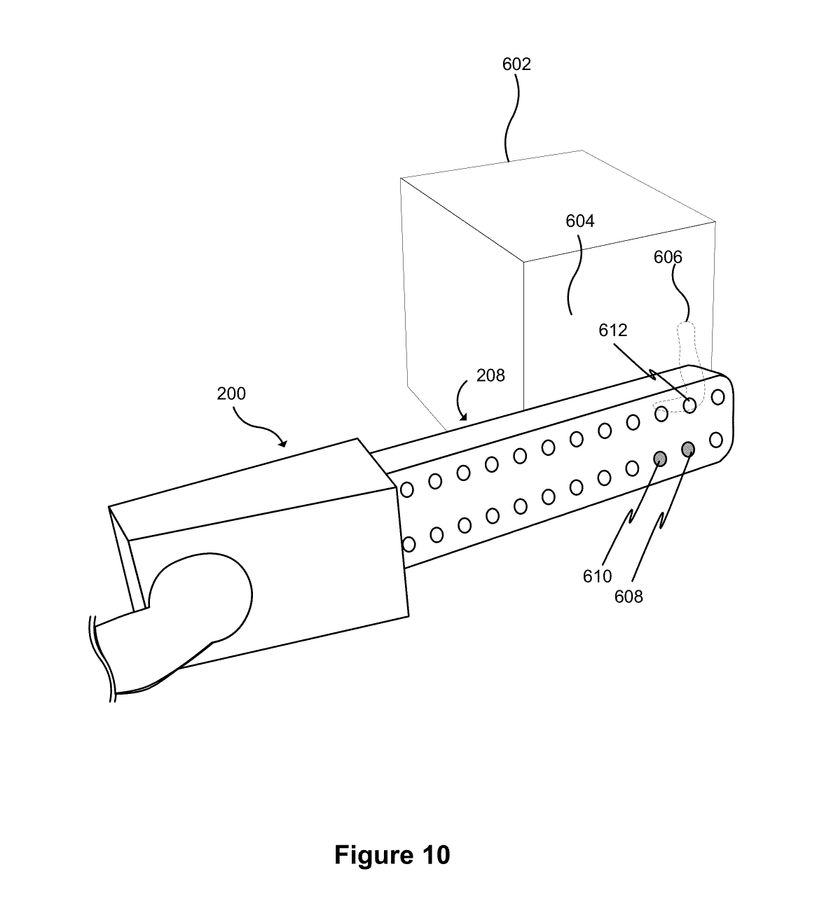

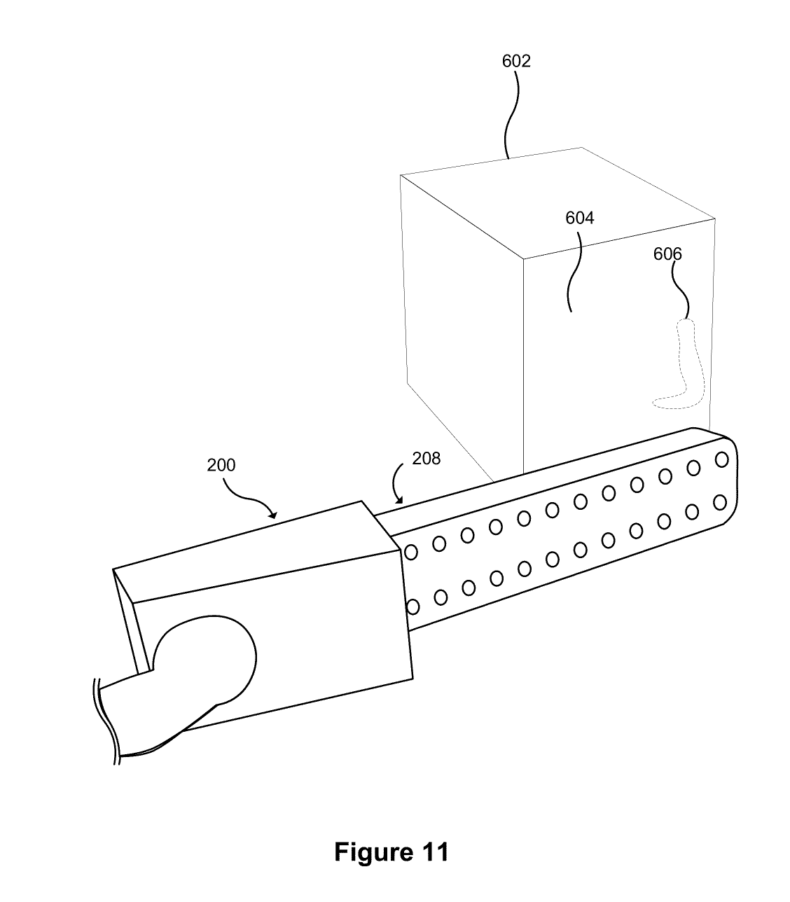

As the detector is moved further in the sweeping direction, the detection volumes will be over a smaller portion of the radiation field 606, and the LEDs of the display are controlled accordingly. As depicted in FIG. 10 the second LED 612 returns to the normal operating colour and brightness as the radiation field intensity detected by the associated detection volume cross below the threshold. Although the field intensity detected by the detection volumes may be below the threshold, and so the second LEDs have returned to the normal operating state, the detection volumes are still detecting the field and as such the LEDs colour and or intensity of the first LEDs 68 and 610 is varied according to the radiation field intensity detected by the associated detection volumes. As the detector is moved further in the sweeping direction as shown in FIG. 11, no more detection volumes are over the radiation field 606, and as such a minimal background field will be detected, and the LEDs will return to the normal operating colour, as depicted.

The above description has described the control of LEDs based on the detected field intensities. Various ways of controlling the LEDs are possible. For example the left hand side LEDs may give feedback on a detected radiation field intensity. At low intensities, the LEDs may be green, at medium intensities the LEDs may be yellow, and at high intensities the LEDs may be red. The right hand side LEDs may be used to give feedback on a difference from average intensity detected across all detection volumes on a blue to red colour scale. As such, both sets of LEDs may always be used to give feedback on the status of the detector tube, with the color and/or intensity providing visual information.

From the above description, it should be appreciated that the radiation detector provides a sensitive combined detection volume that is continuous and gap-free when the detector is moved approximately in the sweeping direction. As such, the radiation detector can detect even pin point radiation fields. Further, since the display comprises a plurality of individual display components located in close proximity to an associated detection volume, the display may provide direct information on the location of the radiation field. Further, since the detector 200 has a sensing portion that extends away from a handle portion, the operator can scan areas without having to have their hand in the area being scanned and which may have a higher than expected radiation field.

A particular embodiment of a radiation detector 200 has been described above. The described radiation detector 200 is only one specific implementation of a radiation detector in accordance with the present disclosure. It is contemplated that other radiation detectors can use the plurality of overlapping detection volumes arranged at an angle to a sweeping direction. Although described as being a hand-held detector, it is possible to provide a detector that is pushed and/or pulled, for example like a broom as described further below.

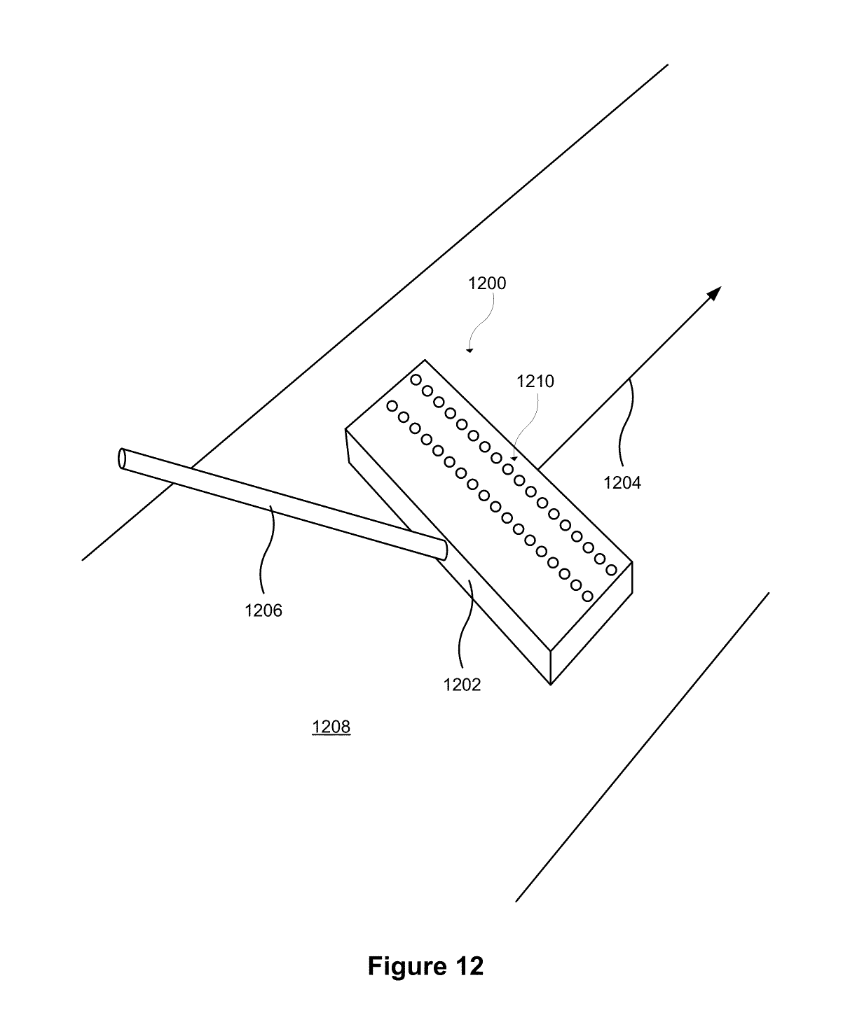

FIG. 12 is a perspective view of a further radiation detector in accordance with the present disclosure. The detector 1200 is similar to the detector 200 in that it comprises a sensing section 1202 with a plurality of detection volumes arranged at an angle to the scanning, or sweeping, direction 1204. However, rather than having a handle attached to the sensing section, the detector 1200 is connected to a broom handle 1206 that allows the detector 1200 to be pushed and/or pulled over a floor 1208 or other surface. Such a detector 1200 may be beneficial to locate any potential areas of radioactive contamination on a floor, for example to identify a location requiring further clean-up or remediation. As depicted, detector 1200 includes a display comprising a plurality of LEDs 1210, with two LEDs being associated with a respective detection volume. The detector 1200 is depicted as having a larger number of detection volumes.

The above description has described arranging the plurality of detection volumes at a common angle to the sweeping direction. It is contemplated that the continuous detection volume in the sweeping direction can be provided by arranging the respective detection volumes at the same or different angles, or in a staggered pattern, to the sweeping direction with ends of adjacent detection volumes overlapping each other.

FIG. 13 is a block diagram depicting a further possible arrangement of detection volumes. The detection volumes 1338a-f (referred to collectively as detection volumes 1338) are arranged in a frame 1306 along a longitudinal axis 1397 of the frame 1306. However, rather than all being arranged at the same angle as depicted in FIG. 5, the detection volumes 1338 are arranged at different angles relative to the sweeping direction 1399. The detection volumes 1338 are arranged with overlapping ends of adjacent detection volumes. As such, the detection volumes 1338 combine to provide a continuous detection volume when moved generally in the sweeping direction 1399.

The individual detection volumes have been depicted above as elongated cylinders. It is contemplated that the radiation detector may use radiation detection volumes of different shapes that are arranged in a staggered pattern to provide a continuous combined detection volume in a sweeping direction. For example, the detection volumes may be hockey-puck or pancake detection volumes, which have the general shape of a flattened cylinder.

FIG. 14 is a block diagram depicting a further possible arrangement of detection volumes. The detection volumes 1438a-f (referred to collectively as detection volumes 1438) are depicted as being pancake type detection volumes. The detection volumes 1438 are arranged in a staggered patter within a frame 1406. The detection volumes 1438 are arranged in a staggered pattern along a longitudinal axis 1497 of the frame 1406. Although the circular detection volumes 1438 do not have respective ends, they are arranged such that each detection volume overlaps with at least one other detection volume to provide a continuous and gap-free combined detection volume in the sweeping direction 1499.

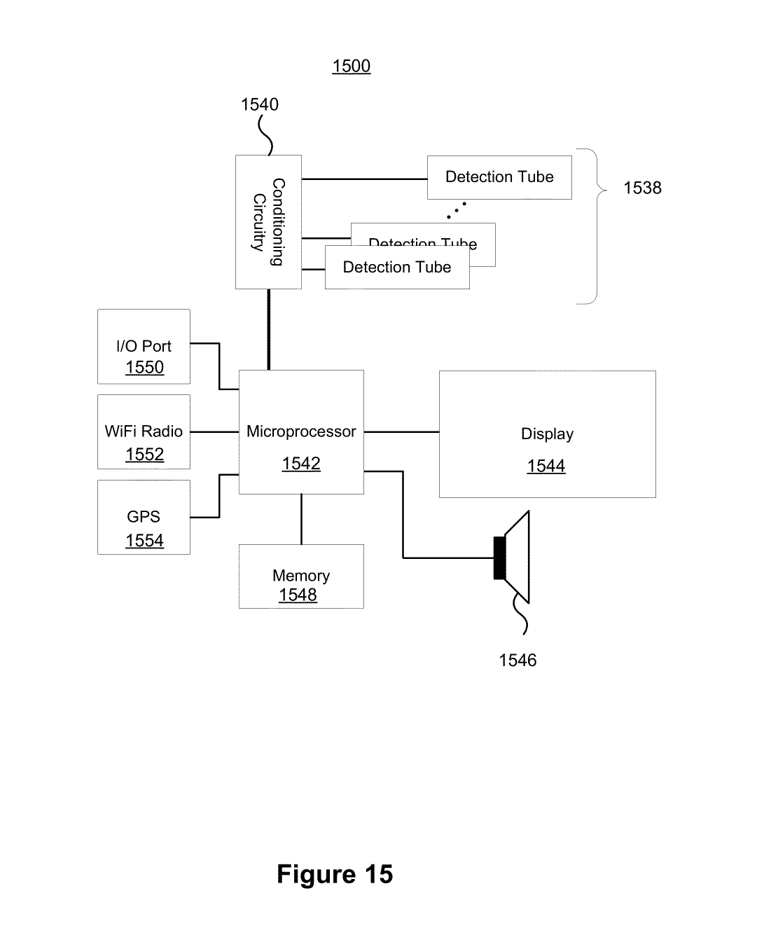

FIG. 15 is a block diagram of components of a further radiation detector. The radiation detector 1500 comprises a plurality of detection volumes 1538 that are connected to condition circuitry 1540. The number of detection volumes may vary depending upon the size of the individual detection volumes used and the desired size of the radiation detector. For example, a handheld device may have 2 to approximately 25 or more detection volumes. A non-handheld detector, for example one to be pushed or pulled, or moved by a vehicle or other means may have a larger number of detection volumes for example 100 or more. It will be appreciated that the number of detection volumes, and their respective sizes may be determined based on the application.

The conditioning circuitry 1540 provides detection signals to a microprocessor 1542. The microprocessor 1542 processes the detection signals and provides feedback to a user based on the detection signals. The feedback may be visual. For example a display 1544 may provide an indication of radiation rates detected by the different detection volumes. The display 1544 may be provided by a plurality of LEDs as described above. Alternatively the display 1544 may be provided by a digital display such as a LCD display panel or other panel types. The microprocessor 1542 may further provide audio feedback through a speaker 1546.

The microprocessor may be coupled to additional components to provide additional functionality. For example, the microprocessor 1542 may be connected to memory 1548, either volatile, non-volatile or both for storing information on detected radiation rates. An I/O port 1550, such as a Universal Serial Bus (USB) or other port may allow the microprocessor to be connected to an external device. The microprocessor 1542 may further allow information, such as the detected radiation rates, stored in memory 1548 to be transferred to the external device across the I/O port 1550. The detector 1500 may further include a WiFi radio 1552 for communicating with an external device. The detector 1500 may also include a GPS receiver 1554 for determining a position of the detector 1500, which may be beneficial in associating a location with detected radiation rates. Other techniques for locating the detector could be used, including triangulation, or trilateration using known positions of detected WiFi transmitters.

Although particular embodiments of radiation detectors have been described in detail, it will be appreciated that various modifications may be made while still providing a radiation detector that provides a plurality of detection volumes arranged to provide a continuous sensing volume. For example, although the above has described the use of detection volumes such as GM tubes, it is contemplated that other radiation detectors could be used. For example GM tubes, scintillation crystals with photomultiplier tubes and/or solid state radiation detectors, referred to collectively as detection volumes, may be used. Further, although the sensing portion has been described as being attached to a handle or broom handle, it is contemplated that the sensing portion could be caused to move in the sweeping direction in other ways, such as by being towed behind a vehicle.

Additionally, while certain embodiments are described with certain components or features, one of ordinary skill in the art will appreciate the certain components and/or features from one embodiment may be incorporated into another embodiment.

What is claimed is:

1. An apparatus for detecting radiation comprising:
an elongate frame having a longitudinal axis; and
a plurality of radiation detection volumes located along the frame and arranged in a staggered pattern relative to a sweeping direction perpendicular to the longitudinal axis.

2. The apparatus of claim 1, wherein each of the radiation detection volumes overlap with at least one other radiation detection volume relative to the sweeping direction thereby providing a continuous and gap-free combined detection volume relative to the sweeping direction.

3. The apparatus of claim 1, further comprising a display for indicating radiation field intensities detected at the plurality of radiation detection volumes.

4. The apparatus of claim 3, wherein the display comprises a plurality of first light emitting diodes (LEDs) each arranged above a respective one of the radiation detection volumes.

5. The apparatus of claim 4, wherein a respective colour and/or brightness of each of the plurality of first LEDs is representative of the radiation field intensity detected by the associated radiation detection volume.

6. The apparatus of claim 4, wherein the display further comprises a plurality of second LEDs each arranged above a respective one of the radiation detection volumes.

7. The apparatus of claim 6, wherein a respective colour and/or brightness of each of the plurality of second LEDs provides a visual indication of additional information of the associated radiation detection volume.

8. The apparatus of claim 7, wherein the additional information comprises one or more of:
an indication of whether the field intensity detected by the associated radiation detection volume is above or below a threshold value;
an indication of a difference between the field intensity detected by the associated radiation detection volume and an average field intensity of the detector; and
an indication of an operating state of the detector.

9. The apparatus of claim 3, further comprising an elongate rectilinear display surface arranged on a top of the frame and covering the display.

10. The apparatus of claim 9, wherein the display surface is made from a transparent, semi-transparent or translucent material that diffuses light from the display.

11. The apparatus of claim 3, wherein the display comprises a plurality of display components each associated with a respective one of the plurality of radiation detection volumes and arranged in close proximity to the associated radiation detection volume.

12. The apparatus of claim 1, further comprising a handle located at a first end, in the longitudinal direction, of the elongate frame.

13. The apparatus of claim 12, further comprising a battery for powering the apparatus coupled to the handle.

14. The apparatus of claim 1, wherein the apparatus comprises between 2 and 100 radiation detection volumes.

15. The apparatus of claim 1, wherein each of the radiation detection volumes is part of a sensor module, each of the sensor modules comprising:
the radiation detection volume;
a signal conditioning board providing electronics for receiving a raw detection signal from the radiation detection volume and providing a detection signal suitable for connection to a microprocessor; and
a first display component of the display for indicating the strength of radiation detected at the radiation detection volume.

16. The apparatus of claim 15, wherein the first display component comprises a light emitting diode (LED), or RGB multi-colour LED.

17. The apparatus of claim 15, wherein each of the sensor modules further comprises a second display component of the display for indicating if the strength of radiation detected at the radiation detection volume is above or below a threshold.

18. The apparatus of claim 17, wherein the second display component comprises an LED, or RGB multi-colour LED

19. The apparatus of claim 1, wherein the detection volumes comprise Geiger-Mueller tubes.

20. The apparatus of claim 1, wherein the detection volumes comprise one or more of:
Geiger-Mueller tubes;
scintillation crystals with photomultiplier tubes; and
solid state radiation detectors.

21. The apparatus of claim 1, wherein the detection volumes are arranged with opposite ends of adjacent detection volumes overlapping to provide a continuous detection volume in the sweeping direction.

22. The apparatus of claim 1, wherein the plurality of radiation detection volumes are arranged at an angle relative to the sweeping direction.

23. The apparatus of claim 1, further comprising a broom handle attached to the elongate frame for moving the apparatus generally in the sweeping direction.
